(19) United States
(12) Patent Application Publication
(10) Pub. No.: US 2012/0000374 A1
(43) Pub. Date: Jan. 5, 2012

(54) FONDUE COOKING APPARATUS

(76) Inventor: Warren Harold BOCK, Peterborough (CA)

(21) Appl. No.: 12/830,394

(22) Filed: Jul. 5, 2010

(51) Int. Cl. A47J 36/00; A47J 37/12

(52) U.S. Cl. 99/413; 99/416; 219/425; 219/432; 219/435

(57) ABSTRACT

A fondue set includes a plurality of utensils, a removable heating vessel for holding a liquid to cook or coat food items, and a fondue stand for holding the heating vessel and the utensils. Each utensil has a food attaching portion for holding a food item. The fondue stand includes a lower portion having a central cavity sized and shaped to hold the removable heating vessel, and an end opening that allows the removable heating vessel to be placed within the central cavity. The stand also includes an upper portion configured to hold the plurality of utensils. The upper portion has a top opening that allows the food attaching portion of the utensils to be placed into the heating vessel.

### TECHNICAL FIELD

The present invention relates to a food preparation device, and more particularly, to a fondue apparatus that may be used for cooking or coating a food item.

### INTRODUCTION

The fondue process involves a central communal fondue pot that all diners can access. The fondue pot is typically supported over a heat source, such as an alcohol burner, in order to heat a liquid or oil in the pot. Diners will place a bite-size food item on their utensil, or fondue fork, and immerse it into the hot liquid contained in the fondue pot in order to cook or coat the food item. During the fondue cooking process, the food item at the end of the fondue fork may end up resting on the bottom of the fondue pot that can lead to the food item burning. Once the item has been adequately cooked or coated, the diner removes their fondue fork from the fondue pot and removes the food item from the fondue fork.

The communal nature of the fondue process is part of its appeal, but it also poses a number of difficulties. The process of inserting and removing the fondue forks from the fondue pot may be awkward, frustrating and unsafe. With multiple diners, the fondue forks may end up being crossed within the fondue pot or mixed up with the other diners.

Accordingly, there is a need for an improved fondue apparatus that may be used for cooking or coating a food item.

### SUMMARY

According to one aspect of the present invention there is provided a fondue set comprising a plurality of utensils, a removable heating vessel for holding a liquid to cook or coat the food items, and a fondue stand for holding the heating vessel and the utensils. Each utensil has a food attaching portion for holding a food item. The fondue stand includes a lower portion having a central cavity sized and shaped to hold the removable heating vessel, and an end opening that allows the removable heating vessel to be placed within the central cavity. The stand also includes an upper portion configured to hold the plurality of utensils. The upper portion has a top opening that allows the food attaching portion of the utensils to be placed into the heating vessel.

Each of the plurality of utensils may have a base portion, and the upper portion of the fondue stand may have a top surface with a plurality of cutout sections formed therein sized and shaped to accept the base portion.

In some embodiments, at least one of the plurality of cutout sections faces inward toward the top opening for positioning and orienting the food attaching portion of one of the plurality of utensils within the removable heating vessel so as to cook or coat the food item held thereon. In some embodiments, at least one of the plurality of cutout sections faces outward from the top opening for positioning and orienting a food attaching portion of one of the plurality of utensils outside the removable heating vessel so as to allow the food item to be attached or removed from the food attaching portion.

In some embodiments, one of the base portion of the utensil and the cutout section includes a magnet, and the other of the base portion of the utensil and the cutout section includes a material magnetically attracted to the magnet so as to magnetically couple the utensil to the fondue stand.

The heating vessel may have a bottom, and the food attaching portion of the utensil may be a fixed distance from the base portion of the utensil so as to position the food attaching portion above the bottom of the heating vessel. The food attaching portion may comprise at least one upward extending tine.

The end opening of the lower portion may be configured to allow the removable heating vessel to be horizontally slid into the central cavity.

The lower portion of the fondue stand may include a base for supporting the heating vessel. The base may have indentations formed therein, and the heating vessel may have a bottom with protrusions therein that correspond and mate with the indentations so as to position the heating vessel within the central cavity.

The heating vessel may comprise an electrical heating element for heating the liquid, and a thermostat control for connecting the removable heating vessel to an electrical outlet so as to power and control the electrical heating element of the heating vessel.

According to another aspect of the present invention there is provided a fondue stand comprising a lower portion and an upper portion. The lower portion having a central cavity sized and shaped to hold a removable heating vessel, and an end opening that allows the removable heating vessel to be placed within the central cavity. The upper portion is configured to hold a plurality of utensils. The upper portion has a top opening that allows a food attaching portion of the utensils to be placed into the heating vessel.

The upper portion may comprise two spaced apart and parallel ledges configured to hold the plurality of utensils.

Each of the ledges may have a top surface with a plurality of cutout sections formed therein for accepting the plurality of utensils. The cutout sections on each ledge may be aligned in a row. The cutout sections may include either a magnet that magnetically attracts a material within one of the utensils, or a material magnetically attracted to a magnet within one of the utensils, so as to magnetically couple the utensil to the fondue stand.

The lower portion may comprises a base for supporting the removable heating vessel, and at least one upright for spacing apart the base and the ledges so as to define the central cavity and the end opening.

Other aspects and features of the invention will become apparent, to those ordinarily skilled in the art, upon review of the following description of some exemplary embodiments.

### BRIEF DESCRIPTION OF THE DRAWINGS

For a better understanding of the various embodiments described herein and to show more clearly how they may be carried into effect, reference will now be made, by way of example only, to the accompanying drawings which show at least one exemplary embodiment, and in which:

FIG. 1 is a perspective view of a fondue set including a fondue stand, a removable heating vessel, and a plurality of utensils, according to one embodiment;

FIG. 2 is a cross-sectional view of the fondue set of FIG. 1;

FIG. 3 is a perspective view of the fondue stand of FIG. 1;

FIG. 4 is a top plan view of the fondue stand of FIG. 1 showing a plurality of cutout sections for receiving the utensils shown in FIG. 1;

FIG. 5 is a partial top plan view of a fondue stand having a cutout section with a different shape according to another embodiment;

FIG. 6 is a perspective view of the fondue utensil of FIG. 1;

FIG. 7 a front elevation view of the fondue utensil of FIG. 1;

FIG. 8 is a side elevation view of the fondue utensil of FIG. 1;

FIG. 9 is a close-up cross-sectional view of the fondue set of FIG. 1, which illustrates a magnet for magnetically coupling the fondue utensil to the fondue stand;

FIG. 10 is a exploded perspective view of the heating vessel of FIG. 1, in which a handle and a thermostat control removed from the heating vessel; and

FIG. 11 is a perspective view of an alternate heating vessel according to another embodiment.

### DETAILED DESCRIPTION

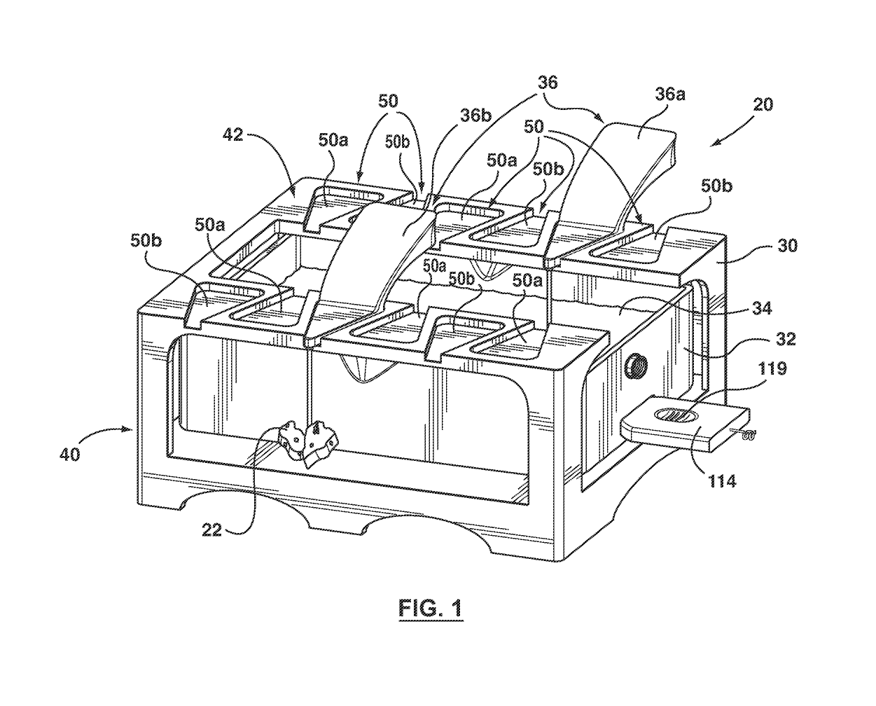

Referring to FIGS. 1-3, illustrated therein is an embodiment of a fondue set 20 made in accordance with the present invention, which may be used to cook or coat food items 22. The fondue set 20 comprises a stand 30, a removable heating vessel 32 for holding a liquid 34 that can be used to cook or coat food items, and a plurality of fondue utensils 36 for holding food items to be cooked or coated.

The liquid 34 within the heating vessel 32 may vary depending on the type of fondue being prepared. For example, the liquid 34 may be cheese, broth or chocolate, which may be used to coat food items such as fruits, cookies, and other food items. Alternatively, when using the fondue set 20 to cook food items such as meat and vegetables, the liquid 34 is typically a cooking oil that is heated prior to cooking the food items.

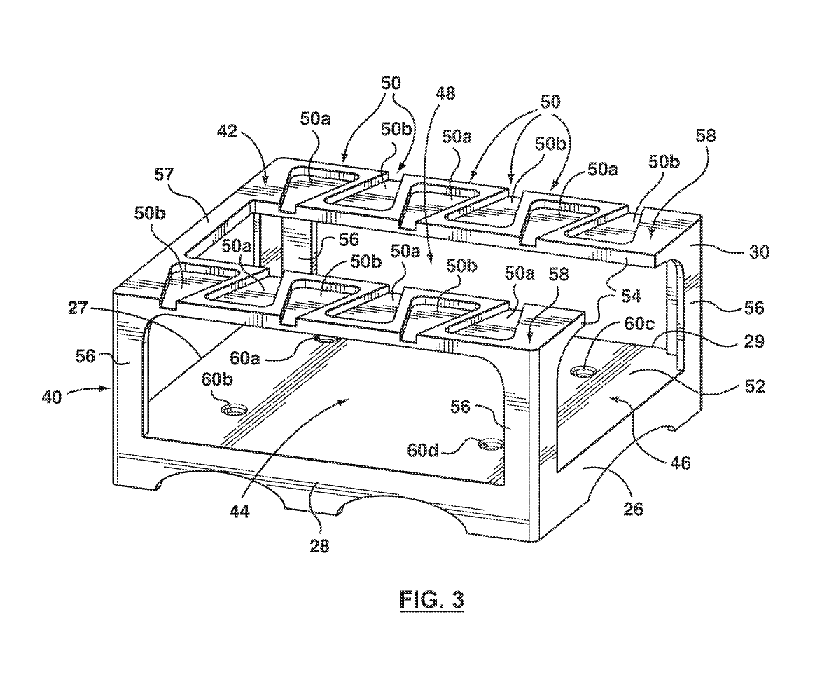

The fondue stand 30 has a lower portion 40 and an upper portion 42. The lower portion 40 has a central cavity 44 therein shaped to receive the removable heating vessel 32, and has an end opening 46 (shown on the right side in FIG. 3) sized and shaped to slidably receive the heating vessel 32 within the central cavity 44.

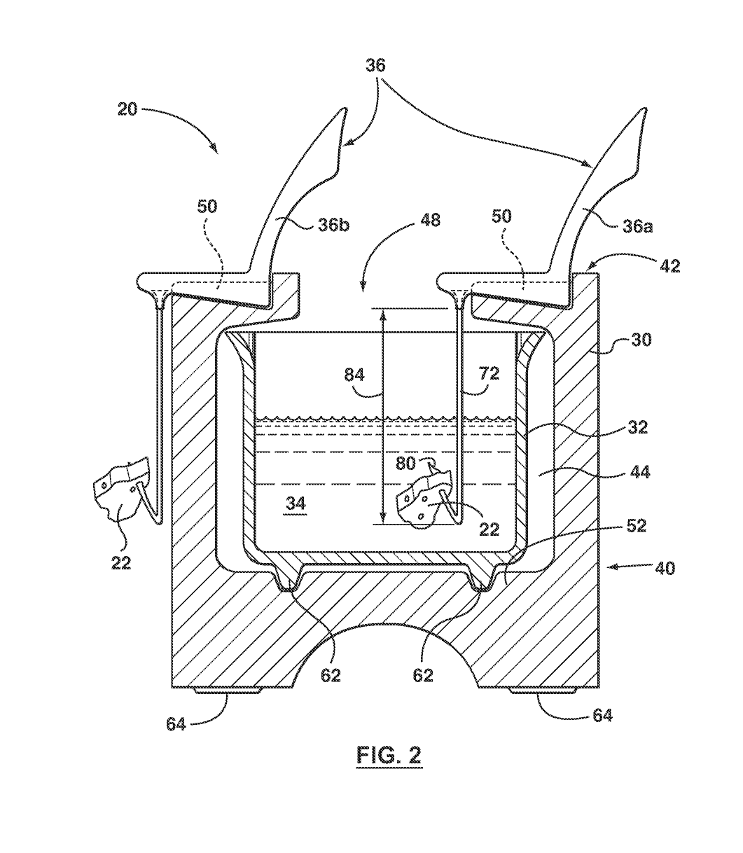

The upper portion 42 of the fondue stand 30 has a top opening 48 (shown in FIGS. 2 and 3) for allowing access to the liquid 34 within the heating vessel 32, and a plurality of triangularly shaped recesses or cutout sections 50 sized and shaped to hold the fondue utensils 36.

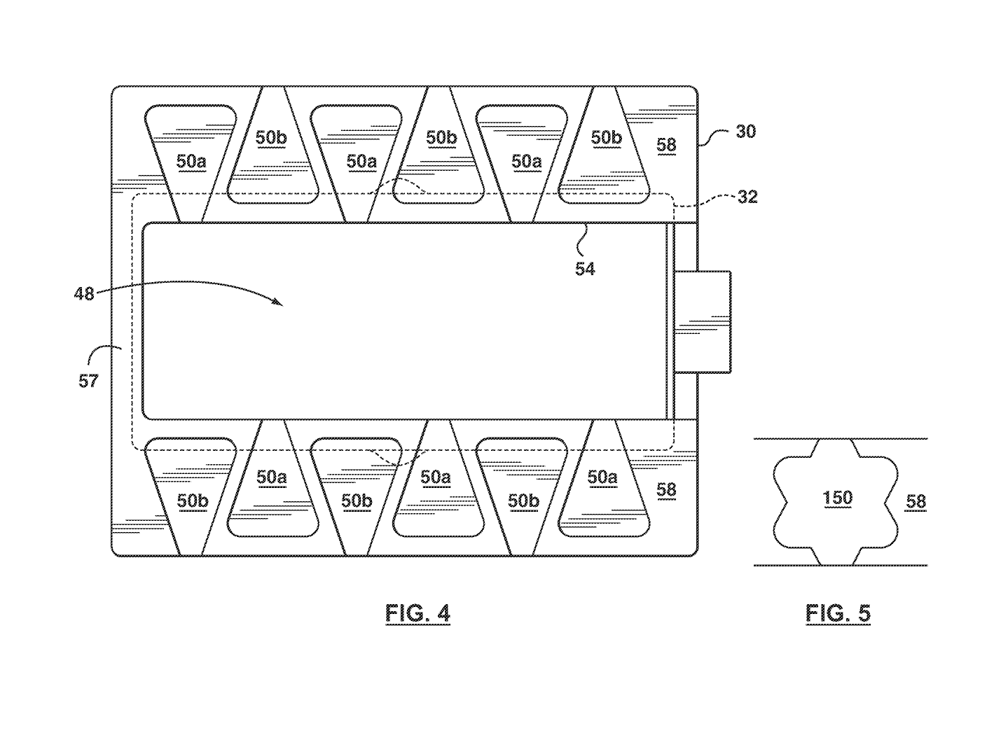

Referring now to FIGS. 3 and 4, the lower portion of the fondue stand 30 has a front end 26, a rear end 27, and two sides 28 and 29. The lower portion 40 also includes a base 52 for supporting the heating vessel 32 when it is received within the cavity 44, and four uprights 56 extending upward from the base 52 so as to support the upper portion 42. In the illustrated embodiment, the uprights 54 are shown as corner posts.

The upper portion 42 of the stand 30 includes two ledges 54 extending along the sides 28 and 29 of the lower portion 40 and supported by the uprights 56 of the lower portion 40. The ledges 54 are parallel and spaced apart by a cross-member 57 located at the rear end 27 of the stand 30. The space between the ledges 54 defines the top opening 48, which provides access to the liquid 34 within the heating vessel 32.

The central cavity 44 is located between the base 52 of the lower portion 40 and the two ledges 54 of the upper portion 42. Furthermore, the end opening 46 is located between the two uprights 56 at the front end 26 of the stand 30, which allows the heating vessel 32 to horizontally slide into a central cavity 44 of the fondue stand 30.

Referring to FIG. 4, the heating vessel 32 is shown positioned within the central cavity 44 of the fondue stand 30. As shown, the ledges 54 may be sized and shaped to overhang and cover a portion of the heating vessel 32 as indicated by the phantom lines in the drawing.

The ledges 54 have a top surface 58 shaped to hold a number of fondue utensils in recesses or cutout sections 50. The cutout sections 50 are shaped to mate with the utensils 36 in order to hold the utensils 36 in a fixed position while preparing, cooking or coating food items 22. In particular, the cutout sections 50 have a triangular shape that corresponds to the triangular shape of the utensils as will be described below.

The cutout sections 50 include inward facing cutout sections 50a that face inward toward the top opening 48 and the heating vessel 32 so as to position and hold the utensils 36 while cooking or coating food items 22 in the liquid 34 within the heating vessel 32 (e.g. see utensil 36a in FIGS. 1 and 2). The cutout sections 50 also include outward facing cutout sections 50b that face outward from the top opening 48 and the heating vessel 32 so as to position and hold the utensils 36 outside the heating vessel 32. For example, the outward facing cutout sections 50b may be used by diners while loading or unloading food items 22 from the utensils 36 (e.g. see utensil 36b in FIGS. 1 and 2).

In the illustrated embodiment, the cutout sections 50 on each ledge 54 are aligned in a row. As shown, the inward facing cutout sections 50a and the outward facing cutout sections 50b may be slightly staggered from each other within each row.

When preparing food items, a diner could use two adjacent cutout sections 50a and 50b (referred to hereinafter as an inward and outward pair) to allow the diner to load/unload food items and cook or coat the food items within the heating vessel 32. Fondue stand 30 provides twelve triangular cutout sections, or six adjacent inward and outward pairs, which would accommodate six diners with three diners on each side of the stand 30.

The orientation and triangular shape of the cutout sections 50 are provided for example purposes only. Some embodiments may include cutout sections with other alternative shapes for holding the utensils 36 in a fixed position while preparing, cooking or coating food items 22. For example, the cutout sections could be circular, square, rectangular and the like.

In some embodiments, each utensil might have a unique shape that corresponds to a cutout shape in the top surface 58. These unique shapes might assist diners in identifying their utensil and its corresponding position along the top surface 58, which may avoid unsanitary sharing of utensils or cooking positions.

Referring to FIG. 5, there is a cutout section 150 with an alternative shape, namely a star shape defined by two opposing triangles superimposed on each other so as to form overlapping inward and outward facing cutout sections. This cutout section 150 may allow a diner to position a utensil with a triangularly shaped cutout section in either the inward or outward direction with respect to the heating vessel, opposed to having two separate cutout sections. This configuration may allow an increased number of staging and cooking/coating areas.

Generally, the fondue stand 30 is constructed from a heat resistant material that inhibits heat transfer from the heating vessel 32 to the stand 30. For example, the stand 30 may be made from heat resistant ceramics, plastics, and the like. A heat resistant construction provides increased safety and allows diners to contact the stand 30 without a significant risk of injury.

In the illustrated embodiment, the ends 26 and 27, and the sides 28 and 29 of the lower portion 40 have openings therein. In other embodiments, one or more of the ends 26 and 27 and the sides 28 and 29 may be solid walls.

In the illustrated embodiment, the end opening 46 for receiving the heating vessel 32 is located at the front end 26 of the fondue stand 30. In other embodiments, there may be openings on the rear end 27, or the sides 28 and 29 of the stand 30 for receiving the heating vessel 32.

While the cutout sections 50 are shown on the ledges 54 along the sides of the stand 30, in some embodiments, the front and rear ends 26 and 27 of the upper portion 42 may also have ledges with cutout sections. These extra cutout sections may increase the number of diners that can use the stand 30.

The fondue stand 30 also has alignment indentations 60a-60d formed on the base 52. Alignment indentations 60a-60d cooperate with corresponding protrusions 62 on the bottom of the heating vessel 32 (see FIG. 2), which allows the heating vessel 32 to be properly aligned within the central cavity 44 of the fondue stand 30. For example, the protrusions 62 may be rubber feet.

While the alignment indentations 60a-60d of the illustrated embodiment are shown as dimples, other embodiments may include other means to align the heating vessel 32 within the fondue stand 32. For example, the base 52 may have a lengthwise groove that interacts with a corresponding ridge on the bottom of the heating vessel 32, which allows the heating vessel 32 to slide along the groove until the heating vessel is in position. The groove may also have dimples within the groove itself corresponding to the final position of the heating vessel 32. The dimples may prevent the heating vessel 32 from sliding beyond its final position.

As shown in FIG. 2, there may be rubber feet 64 attached to the bottom of fondue stand 30, for example, to prevent the stand 30 from sliding on the table or another surface that it is placed upon.

The rectangular shape of the fondue stand 30 in FIG. 3 is provided as an example. Other embodiments of the fondue stand may have a different shape. For example, a circular stand may be constructed that receives a circular vessel within its central cavity.

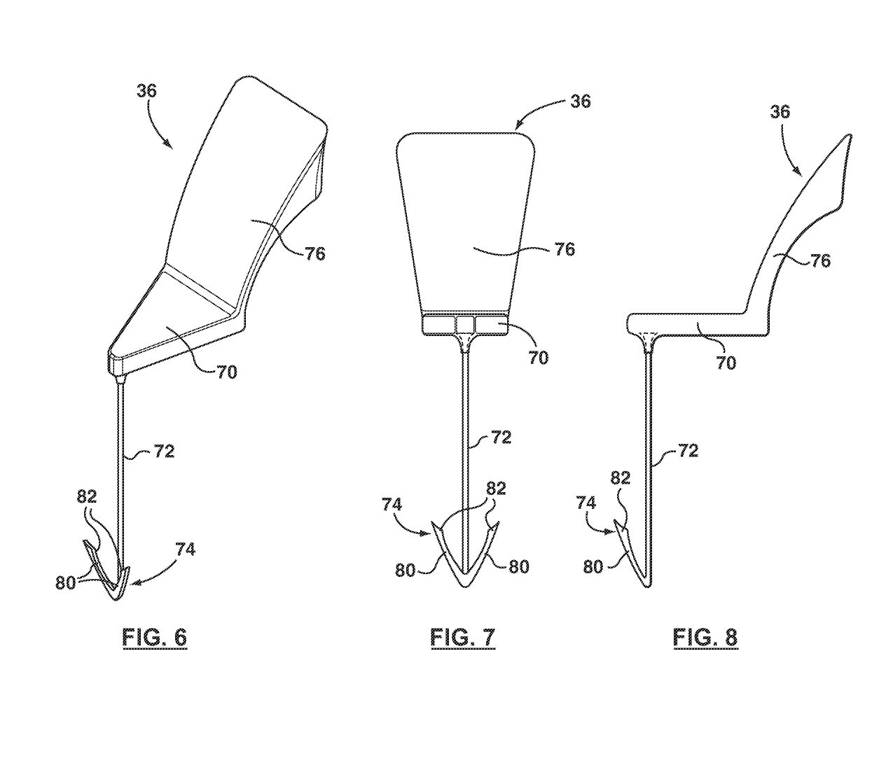

Referring now to FIGS. 6, 7 and 8, the fondue utensil 36 comprises a base portion 70, a shaft 72 extending downwardly from the base portion, and a handle portion 76 extending upwardly from the base portion 70. The base portion 70 has a triangular shape that mates with the cutout sections 50 formed in the top surface 58 of the fondue stand 30. The shaft 72 includes a free end distal from the base portion 70, and a food attaching portion 74 formed on the free end for attaching food items thereto. The handle portion 76 is sized and shaped to allow a diner to pick up and move the fondue utensil 36, for example, to the various cutout sections 50 on the fondue stand 30.

Handle portion 76 is constructed from a heat resistant material to allow the utensil 36 to be safely handled by a diner. The material used may be the same as that used to construct the stand 30. Shaft 72 and food attaching portion 74 may be constructed from stainless steel or another suitable material such as metals, plastics and the like.

As shown, the food attaching portion 74 comprises a pair of upward extending tines 80 having a slight barb 82. Upward facing tines 80 allow the diner to place the food item 22 on the tines 80 with a downward force that keeps the base portion 70 of the utensil 36 engaged with the cutout section 50 of the stand 30. Thus, the fondue utensil 36 tends to remain in a fixed position as food items are placed on the tines 80. The slight barb 82 tends to prevent food items from falling off the tines 80, for example, while the food item is within the liquid 34 in the heating vessel 32. In other embodiments, food attaching portion 74 may be in the form of a fork or skewer, such as those used in some other traditional fondue sets.

Referring again to FIG. 2, the fondue utensil 36a is shown placed within an inward facing cutout section 50a on the top surface 58 of fondue stand 30 and is positioned and oriented inwards toward the heating vessel 32 such that the tines 80 are within the liquid 34 contained in the heating vessel 32.

As shown, the shaft 72 of the fondue utensil 36a has a length 84 selected so that a food item 22 placed on tines 80 will not rest on the bottom of heating vessel 32 and will be submerged in liquid 34. This tends to prevent the food from burning on the bottom of the heating vessel 32 during the heating process, and may also allow equal coating of the food item on all surfaces.

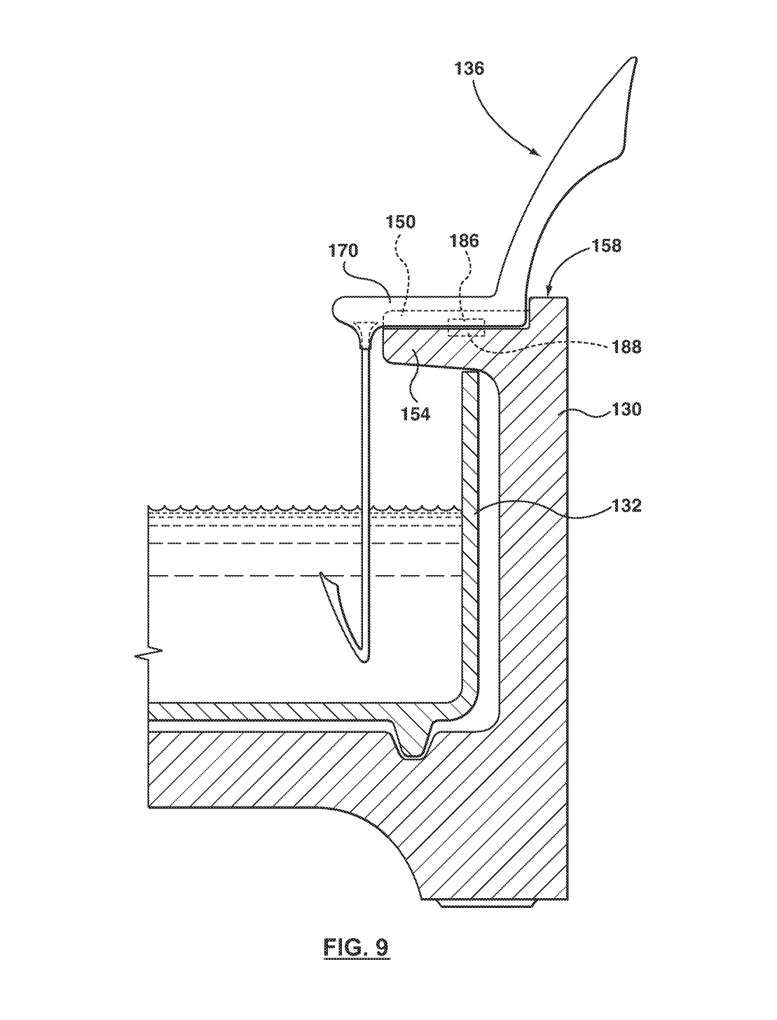

Referring now to FIG. 9, illustrated therein is an alternative embodiment of a fondue stand 130 and cooking utensil 136. The fondue stand 130 and utensil 136 are similar in many respects to the stand 30 and utensil 36 described previously and similar elements are given similar reference numerals incremented by one hundred.

One difference is that the stand 130 and utensil 136 have magnets embedded therein for magnetically coupling the fondue utensil 136 to the ledge 154 of the fondue stand 130. In particular, the utensil 136 includes a magnet 186 embedded within the base portion 170 thereof, and the stand 130 has a second magnet 188 embedded within the ledge 154 and aligned with the cutout section 150. The second magnet 188 is generally polarized opposite to the first magnet 186 so as to magnetically couple the two magnets 186 and 188 when the utensil 136 is placed within the cutout section 150. The magnets 186 and 188 help to secure the fondue utensil 136 in a fixed position on the fondue stand 130.

While the illustrated embodiment includes two magnets, in some embodiments, one of the magnets 186 and 188 may be replaced with a material that is magnetically attracted to the other magnet. For example, one of the magnets 86 and 88 may be replaced by a ferromagnetic material, which may achieve the same result. It will be understood that materials that are magnetically attracted to magnets include magnets, ferromagnetic materials, and the like.

While the illustrated embodiment shows the magnets 186 and 188 as being exposed on the lower surface of the base portion 170 of the utensil 136, and the top surface of the ledge 154 of the stand 130, the magnets 186 and 188 may be embedded below the surface of the base portion 170 or ledge 154 in order to conceal the magnets.

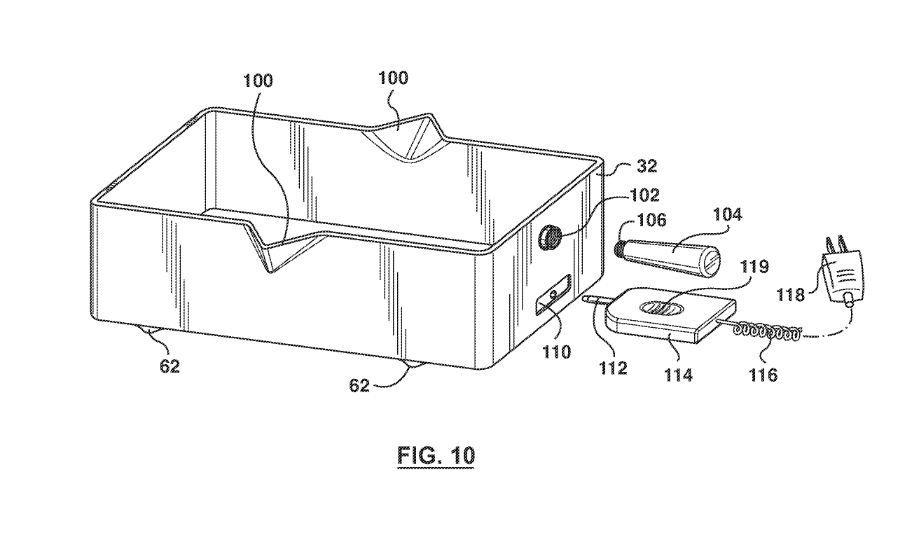

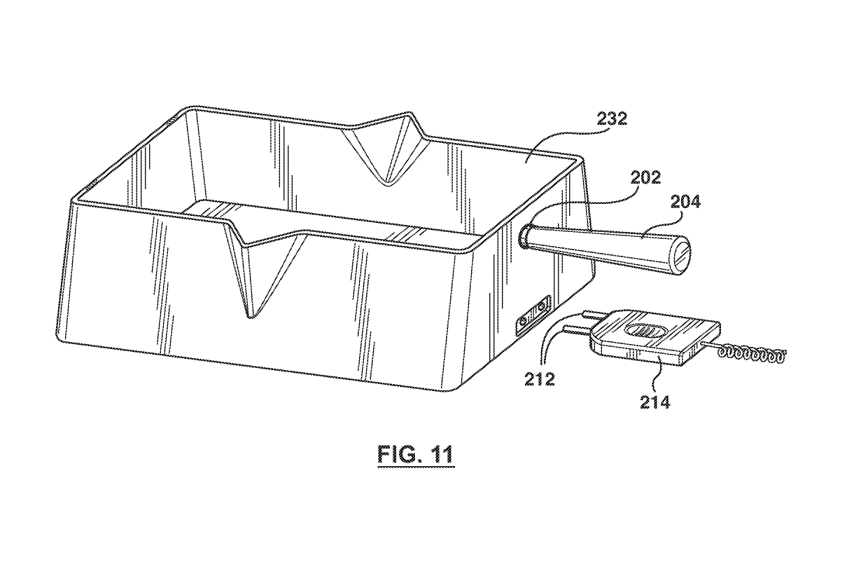

Referring now to FIGS. 10 and 11, the removable heating vessel 32 will be described in greater detail. Heating vessel 32 has a rectangular shape that allows it to fit within the central cavity 44 of the fondue stand 30. The heating vessel 32 may have a volume sized to accept the liquid 34 in a standard size so that there is no need to measure the volume of liquid placed within the heating vessel 32. For example, the volume of the heating vessel 32 may be sized to accept an entire bottle of cooking oil in a commonly available consumer size, such as a 946 mL bottle.

In the illustrated embodiment, the heating vessel 32 is made from a heat conductive material that allows a heating element within vessel 32 to heat the liquids 34 contained therein. For example, the heating vessel 32 may be made from stainless steel, aluminum, copper, and the like.

The heating vessel 34 also has spouts 100 positioned on each side of vessel 32, for example, to remove the liquid 34 from either side of the vessel when emptying or cleaning the vessel 32.

As described previously, protrusions 62 are located on the bottom of the heating vessel 32, and in particular, near the four corners of the bottom of the heating vessel 32. The protrusions 62 are sized and shaped to fit within the indentations 60a-60d on the base 52 of the fondue stand 30.

While the protrusions 62 of the illustrated embodiment are integrally formed with the heating vessel 32, in other embodiments, the protrusions 62 may be formed by affixing material to the bottom of the vessel 32. The affixed protrusions 62 may be made of a heat resistant material that allow a hot vessel 32 to be placed on a surface such as a counter top without causing heat damage to the counter top.

Heating vessel 32 also includes a handle attachment section 102 that allows a handle 104 to be attached to the vessel 32 for placement and removal of the heating vessel 32 within the fondue stand 30. Handle attachment section 102 has a threaded sleeve for receiving a corresponding threaded section 106 of handle 104. The outer portion of handle 104 is constructed of a heat resistant material that allows the heating vessel 32 to be safely moved without injuring or burning the user. Other embodiments may employ different mechanisms for attaching the handle 104 to the heating vessel 32.

Heating vessel 32 also has a receptacle 110 for receiving a probe 112 of thermostat control 114. Probe 102 provides electrical contacts for an electric heating element (not shown) that is embedded within or cast into heating vessel 32. The heating element used may be similar to those used in other household electrical appliances such as electric frying pans and the like.

Thermostat control 114 is connected by power supply cord 116 to plug 118 for use in an electrical outlet, such as a standard 120 VAC receptacle. Thermostat control 114 may also have a temperature control switch 119 that may be used to turn the heating element on, or to select an appropriate temperature.

Probe 112 may also include a temperature sensor, or alternatively, an interface for communicating with a temperature sensor built into the heating vessel 32. In some embodiments the thermostat control 114 may use the data from the temperature sensor to control a light source, such as an LED, within temperature control switch 119 to indicate whether the heating vessel 32 (or the heating element therein) has reached a desired temperature. Temperature control switch 119 may also be configured to select a temperature settings from a plurality of temperature settings, for example, that depend on the liquid 34 or fondue type.

In the illustrated embodiment, the handle 104 and the thermostat control 114 are both removable from the heating vessel 32, which tends to provide compact storage and facilitates packing and shipping by the manufacturer. Having a removable handle 104 and thermostat control 114 might also facilitate cleaning of the heating vessel 32.

Using an electric heating element offers a number of advantages over open flame heat sources used with traditional fondue pots. Electric heating tends to be safer since there is no open flame. When used in conjunction with a temperature sensor, an electric heating element might also provide more precise temperature control.

While the illustrated embodiment refers to an electric heating element, it will be understood that other heating elements could be used such as open flame heat sources, and the like.

Referring now to FIG. 11, there is an alternative embodiment of a heating vessel 232 with a handle 204 screwed into a threaded sleeve 202. The heating vessel 232 also includes a thermostat control 214 having two probes 212 for providing electrical connection to the heating element within the vessel 232.

Referring again to FIG. 1, the heating vessel 32 is shown with the handle 104 removed from the handle attachment section 102. Thermostat control 114 is inserted into receptacle 110 in order to heat the liquid 34. Once the light within temperature control switch 119 of thermostat control switch 114 indicates that the liquid 34 is at the appropriate temperature diners may begin preparing their food items 22.

In use, diners begin preparing food items by placing a fondue utensil 36 within an outward facing cutout section 50b on the upper portion 42 of fondue stand 30. For example, referring to FIG. 1, the fondue utensil 36b faces outwards from the vessel 32 in order to allow food items 22 to be loaded or unloaded from fondue utensil 36b. After a diner has loaded a food item 22 onto their fondue utensil 36b, the utensil 36b may then be positioned on an adjacent inward facing cutout section 50a to immerse the food item 22 in the liquid, as shown with the utensil 36a.

Fondue utensil 36a is placed within an inward facing cutout section 50a on the upper portion 42 of fondue stand 30. Fondue utensil 36a faces inward toward the vessel 32 to allow food items 22 placed on the tines of fondue utensil 36 and submerged in the liquid 34 at an appropriate level above the bottom of the heating vessel 32 for cooking or coating. Because of this placement, the diner does not have to be concerned that the food items 22 might rest on the bottom of the heating vessel 32 and burn, or that the cooking utensil 36a might become entangled with another cooking utensil during the cooking/coating process.

Once the food item 22 has been cooked or coated, the utensil 36a may be repositioned to an adjacent outward facing cutout section 50b so as to remove the food item 22 from the liquid 34. The diner can then unload the food item 22 from the utensil 36a for consumption.

The fondue set 20 of the present invention is believed to have a number of advantages over prior art fondue sets. For example, while traditional fondue pot designs rely on using the fondue pot itself, or a cover placed on the fondue pot, to hold the utensils, the fondue set 20 disclosed herein utilizes a stand 30 that acts as a separate holder for the utensils. While some traditional fondue sets have a stand that is used to support the pot above the heat source, the stand does not hold the utensils either inside or outside the fondue pot. Since these traditional fondue sets lack a device to hold the utensils, the use of traditional fondue pots is prone to mixing up utensils and crossing utensils in the fondue pot, which can be awkward and unsanitary.

In contrast, the pairs of cutout sections 50a and 50b on the stand 30 of the present invention tend to help diners identify which utensils are theirs, and can provide a safer, more orderly dining experience. The pairs of cutout sections 50a and 50b also allow dinners to cook or coat one food item while preparing another food item that will be cooked or coated at a later time.

It will be appreciated by those skilled in the art that the invention can take many forms, and that such forms are within the scope of the invention as claimed. Therefore, the scope of the appended claims should not be limited to the descriptions of the embodiments described herein.

Claims:

1. A fondue set comprising:
(a) a plurality of utensils, each utensil having a food attaching portion for holding a food item;
(b) a removable heating vessel for holding a liquid to cook or coat the food items; and
(c) a fondue stand for holding the heating vessel and the utensils, the fondue stand including:
(i) a lower portion having a central cavity sized and shaped to hold the removable heating vessel, and an end opening that allows the removable heating vessel to be placed within the central cavity; and
(ii) an upper portion configured to hold the plurality of utensils, the upper portion having a top opening that allows the food attaching portion of the utensils to be placed into the heating vessel.

2. The fondue set of claim 1, wherein each of the plurality of utensils have a base portion, and wherein the upper portion of the fondue stand has a top surface with a plurality of cutout sections formed therein sized and shaped to accept the base portion.

3. The fondue set of claim 2, wherein at least one of the plurality of cutout sections faces inward toward the top opening for positioning and orienting the food attaching portion of one of the plurality of utensils within the removable heating vessel so as to cook or coat the food item held thereon.

4. The fondue set of claim 2, wherein at least one of the plurality of cutout sections faces outward from the top opening for positioning and orienting a food attaching portion of one of the plurality of utensils outside the removable heating vessel so as to allow the food item to be attached or removed from the food attaching portion.

5. The fondue set of claim 2, wherein one of the base portion of the utensil and the cutout section includes a magnet, and the other of the base portion of the utensil and the cutout section includes a material magnetically attracted to the magnet so as to magnetically couple the utensil to the fondue stand.

6. The fondue set of claim 2, wherein the heating vessel has a bottom, and the food attaching portion is a fixed distance from the base portion of the utensil so as to position the food attaching portion above the bottom of the heating vessel.

7. The fondue set of claim 6, wherein the food attaching portion comprises at least one upward extending tine.

8. The fondue set of claim 1, wherein the end opening of the lower portion is configured to allow the removable heating vessel to be horizontally slid into the central cavity.

9. The fondue set of claim 1, wherein the lower portion of the fondue stand includes a base for supporting the heating vessel, the base having indentations formed therein, and wherein the heating vessel has a bottom with protrusions therein that correspond and mate with the indentations so as to position the heating vessel within the central cavity.

10. The fondue set of claim 1, wherein the heating vessel comprises an electrical heating element for heating the liquid, and a thermostat control for connecting the removable heating vessel to an electrical outlet so as to power and control the electrical heating element of the heating vessel.

11. A fondue stand comprising:
(a) a lower portion having a central cavity sized and shaped to hold a removable heating vessel, and an end opening that allows the removable heating vessel to be placed within the central cavity; and
(b) an upper portion configured to hold a plurality of utensils, the upper portion having a top opening that allows a food attaching portion of the utensils to be placed into the heating vessel.

12. The fondue stand of claim 11, wherein the upper portion comprises two spaced apart and parallel ledges configured to hold the plurality of utensils.

13. The fondue stand of claim 12, wherein each of the ledges has a top surface with a plurality of cutout sections formed therein for accepting the plurality of utensils.

14. The fondue stand of claim 13, wherein at least one of the plurality of cutout sections faces inward toward the top opening for positioning and orienting a food attaching portion of one of the plurality of utensils within the removable heating vessel so as to cook or coat a food item held thereon.

15. The fondue stand of claim 13, wherein at least one of the plurality of cutout sections faces outward from the top opening for positioning and orienting a food attaching portion of one of the plurality of utensils outside the removable heating vessel so as to allow a food item to be attached or removed from the food attaching portion.

16. The fondue stand of claim 13 wherein the cutout sections on each ledge are aligned in a row.

17. The fondue stand of claim 13, wherein the cutout sections include either a magnet that magnetically attracts a material within one of the utensils, or a material magnetically attracted to a magnet within one of the utensils, so as to magnetically couple the utensil to the fondue stand.

18. The fondue stand of claim 11, wherein the end opening within the lower portion is configured to allow the removable heating vessel to horizontally slide into the central cavity.

19. The fondue stand of claim 11, wherein the lower portion comprises a base for supporting the removable heating vessel, the base having indentations formed therein for receiving corresponding protrusions on a bottom of the removable heating vessel that mate with the indentations so as to position the heating vessel within the central cavity.

20. The fondue stand of claim 12, wherein the lower portion comprises a base for supporting the removable heating vessel, and at least one upright for spacing apart the base and the ledges so as to define the central cavity and the end opening.
